(19) United States
(12) Patent Application Publication
(10) Pub. No.: US 2008/0284770 A1
(43) Pub. Date: Nov. 20, 2008

(54) LIQUID CRYSTAL DISPLAY, METHOD OF ADJUSTING A DRIVING MODE THEREOF AND METHOD OF DRIVING THE SAME

(75) Inventors: Yun-hee KWAK, Seoul (KR); Bo-ra KIM, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/045,254

(22) Filed: Mar. 10, 2008

(30) Foreign Application Priority Data
May 17, 2007 (KR) 10-2007-0048341

(51) Int. Cl. G06F 3/038; G09G 3/36

(52) U.S. Cl. 345/211; 345/87

(57) ABSTRACT

A liquid crystal display includes an insulating substrate, a driving chip having a plurality of input leads and a plurality of option leads, a plurality of input pads and a plurality of option pads. Each input pad of the plurality of input pads is connected to a corresponding input lead of the plurality of input leads, and an input pad of the plurality of input pads supplies the driving chip with a power signal supplied from a power supply wire of a plurality of power supply wires. Each option pad of the plurality of option pads is connected to a corresponding option lead of the plurality of option leads. An operation of the driving chip is controlled according to a voltage level of the power signal supplied through a bridge wire of a plurality of bridge wires connected between an option pad and a corresponding input pad.

This application claims priority to Korean Patent Application No. 10-2007-0048341, filed on May 17, 2007, and all the benefits accruing therefrom under 35 U.S.C. §119, the contents of which in its entirety are herein incorporated by reference.

### BACKGROUND OF THE INVENTION

1. Field of the Invention

The present invention relates to a liquid crystal display (“LCD”) and a method of driving the same and, more particularly, to an LCD having an optimized driving capability by controlling an operation of driving chips mounted on an LCD panel according to various driving conditions and/or driving environments, and a method of driving the same.

2. Description of the Related Art

Currently, an LCD is a popular type of flat panel display. In general, the LCD includes an LCD panel having a first display panel and a second display panel adhered to the first display panel, and a liquid crystal layer interposed therebetween. The LCD typically displays an image using optical modulation, which involves varying optical properties of liquid crystals in the liquid crystal layer.

To drive the LCD panel, driving chips are connected to at least one of the first display panel and the second display panel. The driving chips may be directly mounted on the LCD panel.

After a manufacturing process whereby the driving chips are mounted on the LCD is completed, however, it is not possible to change an operation of the driving chips according to various driving conditions and/or environments. As a result, when an operational error occurs in an LCD and/or an optimized driving capability, e.g., a driving capability different from a driving capability established during the manufacturing process of the LCD is desired, a new LCD must be manufactured, which is inefficient.

### BRIEF SUMMARY OF THE INVENTION

Exemplary embodiments of the present invention include a liquid crystal display (“LCD”) and a method of adjusting a driving mode of the LCD by adjusting an operation of a driving chip mounted on an LCD panel of the LCD according to a changed driving condition and/or operating environment of the LCD.

Exemplary embodiments of the present invention also provide a method of driving the LCD.

According to an exemplary embodiment of the present invention, an LCD includes an insulating substrate, a driving chip mounted in a chip mounting area on the insulating substrate and having a plurality of input leads and a plurality of option leads, a plurality of input pads formed in a chip mounting area, each input pad of the plurality of input pads being connected to a corresponding input lead of the plurality of input leads, wherein an input pad of the plurality of input pads supplies the driving chip with a power signal supplied from a power supply wire of a plurality of power supply wires, a plurality of option pads formed in a chip mounting area, and which control the driving chip by the power signal, and a plurality of bridge wires connecting the input pads and the option pads, wherein parts of the bridge wires are formed out of the chip mounting area.

The plurality of input pads and the plurality of option pads are disposed in a chip mounting area on the insulation substrate. The chip mounting area has an inner area and an outer peripheral area surrounding the inner area and has a driving chip mounted therein, and a bridge wire of the plurality of bridge wires extends from a power supply wire of plurality of power supply wires disposed in the inner area of the chip mounting area to an option pad disposed in the outer peripheral portion of the chip mounting area.

In an alternative exemplary embodiment, the plurality of input pads and the plurality of option pads are disposed inside a chip mounting area on the insulation substrate having an inner area and an outer peripheral area surrounding the inner area and having a driving chip mounted therein, and a bridge wire of the plurality of bridge wires extends from a power supply wire of the plurality of power supply wires disposed outside the chip mounting area toward to an option pad disposed in the outer peripheral area of the chip mounting area.

The liquid crystal display may further include an additional bridge wire of the plurality of bridge wires extending from an additional power supply wire of the plurality of power supply wires disposed in the inner area of the chip mounting area to an additional option pad disposed in the outer peripheral area of the chip mounting area.

Further, an option lead of the plurality of option leads may be connected to an option pad of the plurality of option pads and receive the power signal from a corresponding bridge wire of the plurality of bridge wires to control an operation of the driving chip according to a voltage level of the power signal.

The plurality of option leads includes a signal option lead, a voltage option lead and a driving option lead. The signal option lead controls one of a driving signal and a control signal generated from the driving chip, the voltage option lead controls a magnitude of a driving voltage of the driving chip and the driving option lead controls a driving mode of the driving chip.

The plurality of power supply wires includes a driving voltage wire to which a driving voltage signal is applied and a ground voltage wire to which a ground voltage signal is applied. In addition, the plurality of bridge wires applies one of the driving voltage signal and the ground voltage signal to an option lead of the plurality of option leads.

An internal circuit of the driving chip pulls up or pulls down a floated option lead when a bridge wire of the plurality of bridge wires connected to the floated option lead of the plurality of option leads is opened.

In an exemplary embodiment, the driving chip is mounted by a chip-on-glass type. In addition, the driving chip may further include a plurality of signal leads to which one of an outside driving signal and an outside control signal is applied, the insulating substrate may further include a plurality of signal pads, each of which is connected to a corresponding signal lead of the plurality of signal leads, and signal pads of the plurality of signal pads may each be connected to a signal wire of a plurality of signal wires formed on the insulating substrate.

According to an alternative exemplary embodiment of the present invention, a method of adjusting a driving mode of the an LCD includes forming the LCD, testing an operation of the LCD, and adjusting the driving mode of the liquid crystal display by selectively opening a bridge wire of the plurality of bridge wires connected between an option pad and a corresponding input pad.

The method may further include mounting the driving chip in a chip mounting area on the insulating substrate having an inner area and an outer peripheral area surrounding the inner area; forming a bridge wire of the plurality of bridge wires to extend from the inner area of the chip mounting area to the outer area of the chip mounting area the outside of the chip mounting area; and adjusting the driving mode of the liquid crystal display by floating an option lead of the plurality of option leads.

The method may further include adjusting a voltage level of an option lead of the plurality of option leads by an internal circuit of the driving chip when the option lead of the plurality of option leads is floated.

The method may further include one of pulling up and pulling down a voltage level of the option lead by the internal circuit of the driving chip when the option lead of the plurality of option leads is floated.

The selectively opening the bridge wire connected between an option pad and a corresponding input pad may include cutting the bridge wire. Further, the bridge wire may be cut with a laser.

The plurality of option leads may include a signal option lead, a voltage option lead and a driving option lead, and the method may further include controlling one of a driving signal and a control signal generated from the driving chip with the signal option lead, controlling a magnitude of a driving voltage of the driving chip with the voltage option lead, and controlling a driving mode of the driving chip with the driving option lead.

The plurality of power supply wires may include a driving voltage wire to which a driving voltage signal is applied and a ground voltage wire to which a ground voltage signal is applied, and the plurality of bridge wires may apply one of the driving voltage and the ground voltage to an option lead of the plurality of option leads.

In yet another alternative exemplary embodiment of the present invention, a method of driving the liquid crystal display includes connecting an option lead of the plurality of option leads to an option pad of the plurality of option pads to receive the power signal from a corresponding bridge wire and controlling an operation of the driving chip according to a voltage level of the power signal.

### BRIEF DESCRIPTION OF THE DRAWINGS

The above and other aspects, features and advantages of the present invention will become more readily apparent by describing in further detail exemplary embodiments thereof with reference to the accompanying drawings, in which:

FIG. 1A is a bottom perspective view of a driving chip of a liquid crystal display (“LCD”) according to an exemplary embodiment of the present invention;

FIG. 1B is a bottom perspective view of a driving chip of an LCD according to an alternative exemplary embodiment of the present invention;

FIG. 2 is a partial exploded top perspective view of an LCD panel assembly of an LCD according to an exemplary embodiment of the present invention;

FIG. 3 is an enlarged plan view of a portion “E” of the LCD panel assembly of the LCD according to the exemplary embodiment of the present invention in FIG. 2;

FIG. 4 is an enlarged plan view of a portion “E” of an LCD panel assembly according to an alternative exemplary embodiment of the present invention in FIG. 2;

FIG. 5 is a flowchart of a method of driving an LCD according to an exemplary embodiment of the present invention; and

FIG. 6 is a processing diagram illustrating a step of varying operation of a driving chip in the method of driving the LCD according to the exemplary embodiment of the present invention in FIG. 5.

### DETAILED DESCRIPTION OF THE INVENTION

The invention will now be described more fully hereinafter with reference to the accompanying drawings, in which exemplary embodiments of the invention are shown. The present invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including,” when used in this specification, specify the presence of stated features, regions, integers, steps, operations, elements and/or components, but do not preclude the presence or addition of one or more other features, regions, integers, steps, operations, elements, components and/or groups thereof.

Furthermore, relative terms, such as “lower” or “bottom” and “upper” or “top” may be used herein to describe one element's relationship to other elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on the “upper” side of the other elements. The exemplary term “lower” can, therefore, encompass both an orientation of “lower” and “upper,” depending upon the particular orientation of the figure. Similarly, if the device in one of the figures were turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning which is consistent with their meaning in the context of the relevant art and the present disclosure, and will not be interpreted in an idealized or overly formal sense unless expressly so defined herein.

Exemplary embodiments of the present invention are described herein with reference to cross section illustrations which are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes which result, for example, from manufacturing. For example, a region illustrated or described as flat may, typically, have rough and/or nonlinear features. Moreover, sharp angles which are illustrated may be rounded. Thus, the regions illustrated in the figures are schematic in nature and their shapes are not intended to illustrate the precise shape of a region and are not intended to limit the scope of the present invention.

Hereinafter, the exemplary embodiments of the present invention will be explained in further detail with reference to the accompanying drawings.

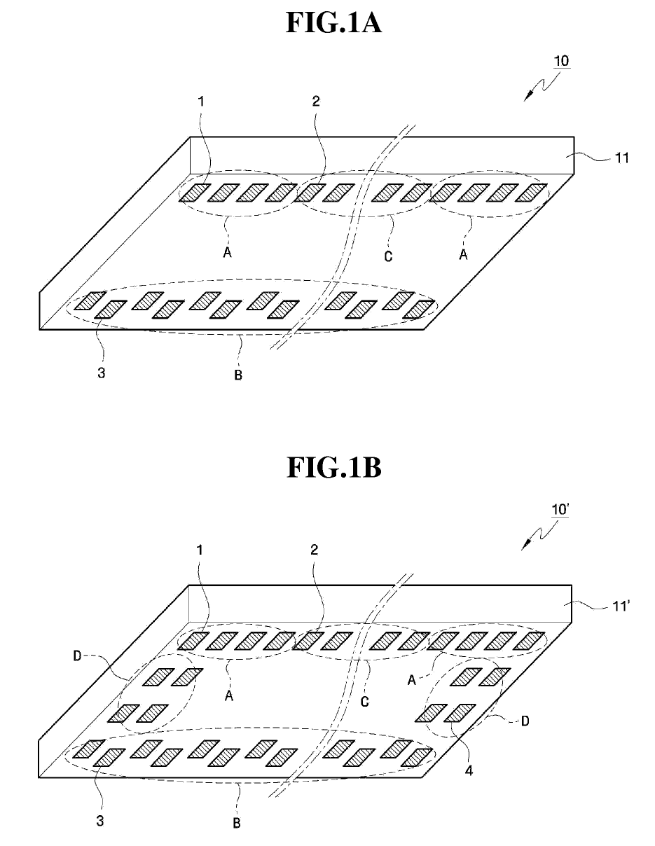

Hereinafter, exemplary embodiments of the present invention will be explained in further detail with reference to the accompanying drawings. A driving chip in a liquid crystal display (“LCD”) according to an exemplary embodiment of the present invention will now be described in further detail with reference to FIGS. 1A and 1B.

FIG. 1A is a bottom perspective view of a driving chip of an LCD according to an exemplary embodiment of the present invention and FIG. 1B is a bottom perspective view of a driving chip of an LCD according to an alternative exemplary embodiment of the present invention.

Referring to FIG. 1A, a driving chip 10 includes an input lead 1, an option lead 2 and an output lead 3 (collectively referred to as a plurality of connection leads) disposed on a bottom surface of a chip body 11 and connected to an outside circuit (not shown).

In an exemplary embodiment, the driving chip is disposed on an insulting substrate. Further, the plurality of connection leads is connected to an internal circuit (not shown) of the driving chip 10, and is divided into three sections. More specifically, the plurality of connection leads is divided into an input portion A having a plurality of input leads 1, an output portion B having a plurality of output leads 3 and an option portion C having a plurality of option leads 2.

Individual leads of the plurality of input leads 1 may be classified as signal leads and/or power supply leads according to a type of signal applied from the outside.

The input portion A and the option portion C of the driving chip 10 may be disposed along a substantially longitudinal axial line on the bottom surface of the chip body 11, and the output portion B may be disposed opposite to and facing the input portion A and the option portion C along a second substantially longitudinal axial line on the bottom surface of the chip body 11, as shown in FIG. 1A.

The plurality of input leads 1 and the plurality of option leads 2 of the input portion A and the option portion C, respectively, receive predetermined outside signals such as driving, control and power signals, for example, but are not limited thereto.

The plurality of output leads 3 of the output portion B supply an output signal, supplied from the input portion A and processed in internal circuits (not shown) of the driving chip 10, to an outside circuit (not shown). More specifically, the input portion A of the driving chip 10 receives the driving, control and/or power signals from the outside, e.g., from a printed circuit board (“PCB”), through the plurality of input leads 1, and supplies the driving, control and/or power signals to the internal circuits of the driving chip 10, where these signals are processed and supplied from the plurality of output leads to the outside circuit as the output signal.

In an exemplary embodiment, the outside signals supplied to the input portion A may further include, for example, data signals and gamma signals from an LCD panel (not shown), but are not limited thereto. In addition, the outside signals may include, for example, driving voltage signals or ground voltage signals, but are not limited thereto in alternative exemplary embodiments of the present invention.

Further, the option portion C controls an operation of the driving chip 10 using the signals supplied from the outside. Individual leads of the plurality of option leads 2 include a signal option lead, a voltage option lead and a driving option lead, for example, but are not limited thereto. The option portion C of the driving chip 10 will now be described in further detail with reference to Table 1.

TABLE 1
Example Operations and States of the Option Portion C
of the Driving Chip 10 According to an Exemplary
Embodiment of the Present Invention.

| Type of Option | | Posisble States |
|---|---|---|
| Lead 2 | Operation of Driving Chip 10 | of Option Lead 2 |
| Signal option lead | Control driving signal and/or | High, Low, Floating |
| | control signal | (Pull-down) |
| Voltage option lead | Control magnitude of driving | High, Low, Floating |
| | voltage | (Pull-up) |
| Driving option lead | Control driving mode | High, Low, Floating |
| | | (Pull-up) |

Referring to Table 1, the signal option lead controls a driving signal and/or a control signal generated by the driving chip 10. For example, in an exemplary embodiment in which the driving chip 10 is mounted on the LCD panel (not shown), the signal option lead may selectively control the generation of driving and/or control signals according to a magnitude of a resistance component of the LCD panel. More specifically, levels of the signal option lead may selectively be at a different state, e.g., a high state, a low state or a floating (pull-down) state, according to a signal supplied from the outside.

The voltage option lead controls a magnitude of a driving voltage of the driving chip 10. For example, in an exemplary embodiment in which the driving chip 10 is mounted on the LCD panel, the voltage option lead may selectively control the magnitude of the driving voltage of the driving chip 10. Further, levels of the voltage option lead may selectively be in a different state, e.g., a high state, a low state or a floating (pull-up) state, according to a signal supplied from the outside.

Finally, the driving option lead controls a driving mode, e.g., a driving method, of the driving chip 10. For example, in an exemplary embodiment in which the driving chip 10 is mounted on the LCD panel, the driving option lead may control the driving chip 10 to selectively be driven by a current or by a voltage supplied form the outside. Levels of the driving option lead may selectively be in a different state, e.g., a high state, a low state or a floating (pull-up) state, according to a signal supplied from the outside, as will be now described in further detail with reference to Table 1.

An operation of the driving chip 10 is controlled according to a state of the driving option lead in the following manner. The driving chip 10 may be mounted on the LCD panel (not shown), as described in further detail below. As described above, the plurality of option leads 2 of the driving chip 10 may include the driving option lead which controls a driving mode of the driving chip 10. More specifically, the driving chip 10 may have three states, as shown in Table 1, each corresponding to a particular driving mode of the driving chip 10. For example, when a level of the driving option lead is at a high state, the driving chip 10 operates according to an external current. When a level of the driving option lead is at a low state, the driving chip 10 operates according to an outside voltage. When a level of the driving option lead is at a floating (pull-up) state, the driving chip 10 goes into a pull-up state.

Thus, in an exemplary embodiment, when a predetermined outside signal, e.g., a driving voltage, is applied to the driving option lead of the driving chip 10 by the LCD panel, a level of the driving option lead goes to a high state, and an operation of the driving chip 10 is thereafter controlled such that the driving chip 10 is driven by a current supplied from the LCD panel. In contrast, if an outside signal having a different level, e.g., a ground voltage, is applied to the driving option lead, a level of the driving option lead goes to a low state. Accordingly, operation of the driving chip 10 is thereafter controlled such that the driving chip 10 is driven by a voltage supplied from the LCD panel. Finally, if no outside signal, e.g., neither the driving voltage nor the ground voltage, is applied to the driving option lead, the driving option lead is at a floating state. In this case, a level of the driving option lead goes into a pull-up state determined according to an internal circuit of the driving chip 10, and a level of the driving option thereby lead goes to a high state. Accordingly, the operation of the driving chip 10 is thereafter controlled such that the driving chip 10 is driven by a current supplied from the LCD panel.

While a driving chip having three types of option leads, e.g., the signal option lead, the voltage option lead and the driving option lead, has been described with reference to an exemplary embodiment, alternative exemplary embodiments of the present invention are not limited thereto, and the driving chip may have various other types of option leads.

A driving chip according to an alternative exemplary embodiment of the present invention will now be described in further detail with reference to FIG. 1B. A driving chip 10′ in FIG. 1B has substantially the same configuration as the driving chip 10 according to the exemplary embodiment in FIG. 1A except as described below.

Referring to FIG. 1B, the driving chip 10′ according to an alternative exemplary embodiment of the present invention includes a power supply lead 4 supplied with an outside power.

More specifically, the driving chip 10′ includes a plurality of connection leads, e.g., a plurality of input leads 1, a plurality of option leads 2, a plurality of output leads 3, and a plurality of power leads 4 mounted on a bottom surface of a chip body 11′ and connected to outside circuits (not shown). Further, the plurality of connection leads is connected to internal circuits (not shown) of the driving chip 10′ and may be divided into an input portion A, an output portion B and an option portion C, as described above in further detail, of the driving chip 10′.

Referring to FIG. 1B, the driving chip 10′ may further include a power supply portion D having the plurality of power supply leads 4 to which an outside power signal such as a driving voltage signal or a ground voltage signal, for example, is applied from an outside circuit.

The plurality of power supply leads 4 may be disposed at a side of the bottom surface of the chip body 11′, e.g., between the plurality of input leads 1 and/or the option leads 2 and the output leads 3, for example, as shown in FIG. 1B, but is not limited thereto in alternative exemplary embodiments.

As described above, the power supply portion D of the driving chip 10′ is formed in an area separate from the input portion A of the driving chip 10′, thereby reducing a number of input leads 1. As a result, a size of the driving chip is effectively reduced.

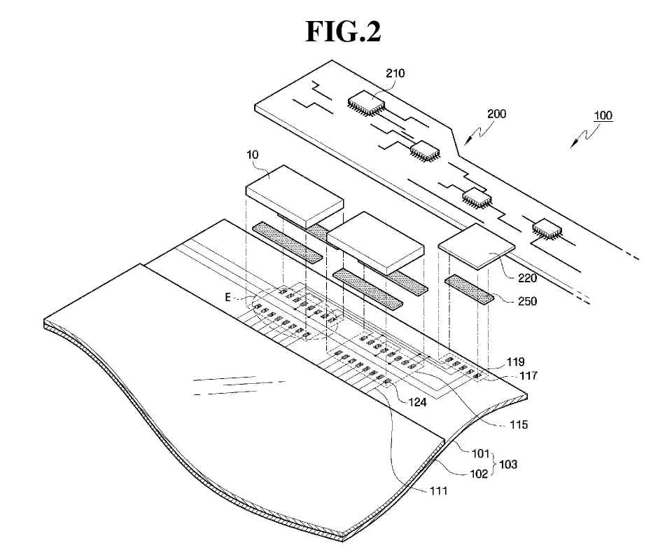

An LCD according to an exemplary embodiment of the present invention will now be described in further detail with reference to FIGS. 2 through 4. For convenience of explanation, an LCD having the driving chip 10 shown in FIG. 1A will be described, but alternative exemplary embodiments of the invention are not limited thereto. For example, the driving chip 10′ shown in FIG. 1B may be used in an LCD (not shown) according to an alternative exemplary embodiment of the present invention.

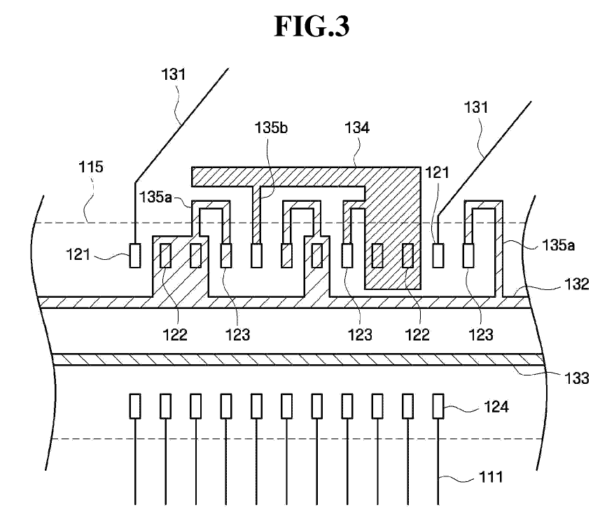

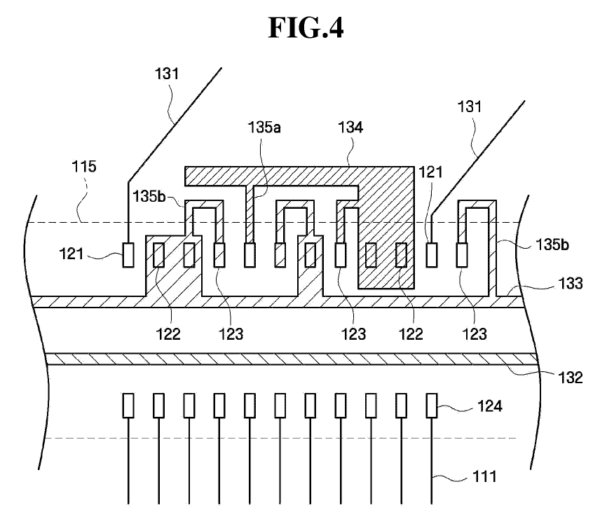

FIG. 2 is a partial exploded top perspective view of an LCD panel assembly of an LCD according to an exemplary embodiment of the present invention, FIG. 3 is a partial enlarged plan view of a portion “E” of the LCD panel assembly of the LCD according to the exemplary embodiment of the present invention in FIG. 2, and FIG. 4 is a partial enlarged plan view of a portion “E” of an LCD panel assembly according to an alternative exemplary embodiment of the present invention in FIG. 2.

Referring to FIGS. 1A, 2 and 3, an LCD panel assembly 100 of an LCD according to an exemplary embodiment of the present invention includes an LCD panel 103, a driving chip 10 and a PCB 200.

The LCD panel 103 includes a first display panel 101, a second display panel 102 and a liquid crystal layer (not shown) interposed therebetween.

In an exemplary embodiment, the first display panel 101 and the second display panel 102 may include insulating substrate as base plates, respectively.

The first display panel 101 includes a plurality of gate lines (not shown), a plurality of data lines 111, thin film transistors (not shown), and pixel electrodes (not shown) on insulating substrate. The second display panel 102 is smaller than the first display panel 101, e.g., the second display panel 102 does not completely cover the first display panel 101, as shown in FIG. 2, and may include a light-blocking pattern (not shown), a color filter (not shown) and a common electrode (not shown). The first display panel 101 and the second display panel 102 are attached to each other to define an effective display area of the LCD panel 103, e.g., an area where the second display panel 102 covers the first display panel 101. A liquid crystal layer (not shown) containing liquid crystal molecules having optical anisotropy is interposed between the first display panel 101 and the second display panel 102.

A chip mounting area 115 having the driving chip 10 mounted therein is formed on an area of the first display panel 101 not covered by the second display panel 102, e.g., in a non-effective display area of the LCD panel 103. A longitudinal side of the chip mounting area 115 may be substantially parallel to a longitudinal side of the LCD panel 103, for example, but is not limited thereto in alternative exemplary embodiments.

A plurality of connection pads 121, 122, 123 and 124 is formed in the chip mounting area 115. The plurality of connection pads 121, 122, 123 and 124 are each connected to a corresponding input lead 1, option lead 2 or output lead 3 of the plurality of connection leads of the driving chip 10. Further, the plurality of connection pads may include, for example, a plurality of first input pads 121, a plurality of second input pads 122, a plurality of output pads 124 and a plurality of option pads 123.

In an exemplary embodiment, the plurality of first input pads 121, the a plurality of second input pads 122 and the plurality of option pads 123 may be disposed on a substantially longitudinal axial line in a similar manner as described above in greater detail with respect to the plurality of input leads 1 and the plurality of option leads 2 of the driving chip 10, and the plurality of output pads 124 may be disposed opposite to and facing the plurality of first input pads 121, the plurality of second input pads 122 and the plurality of option pads 123, as shown in FIG. 3.

Each of the plurality of first input pads 121 and the plurality of second input pads 122 is connected to a corresponding input lead 1 of the plurality of input leads 1 of the driving chip 10, and are supplied with outside signals which are subsequently supplied to the plurality of input leads 1 of the driving chip 10.

In addition, the plurality of first input pads 121 and the plurality of second input pads 122 may include a signal pad, for example to which outside driving and/or control signals are applied. And the plurality of second input pads 122 may include a power supply pad connected to a corresponding the power supply lead 4 of the driving chip 10, and the outside power signals may be applied to the power supply pad.

The plurality of output pads 124 are each connected to a corresponding output lead 3 of the plurality of output leads 3 of the driving chip 10, and may be supplied with a signal processed by the driving chip 10 through the plurality of output leads 3 to provide a processed signal to an outside circuit, for example.

The plurality of option pads 123 are each connected to a corresponding option lead 2 of the plurality of option leads 2 of the driving chip 10, and provide outside signals such as a power signal, for example, to the plurality of option leads 2, thereby controlling an operation of the driving chip 10, as described above in greater detail.

Referring again to FIG. 3, the LCD panel 103 includes a plurality of signal wires 131, a plurality of power supply wires 132, a plurality of power supply wires 133, a plurality of power supply wires 134, a plurality of first bridge wires 135a and a plurality of second bridge wires 135b, hereinafter collectively referred to as a plurality of wires. Individual wires of the plurality of wires are each connected to a corresponding first input pad 121, second input pad 122, option pad 123 or output pad 124 of the plurality of connection pads 121, 122, 123 and 124. Further, the plurality of signal wires 131 are supplied with driving and/or control signals of the driving chip 10 and/or the LCD panel 103, from an outside circuit, e.g., the PCB 200, and individual power supply wires 132, 133 and 134, respectively, are each supplied with power signals of the driving chip 10 and/or the LCD panel 103, and first bridge wires 135a and second bridge wires 135b branch from individual power supply wires 132, 133 and 134.

More specifically and still referring to FIG. 3, the plurality of signal wires 131 extend from the first input pads 121 to connect to the PCB 200 (FIG. 2). Further, the plurality of signal wires 131 supplies the driving and/or control signals supplied from the PCB 200 to the first input pads 121. The first input pads 121 thereby provide the driving and/or control signals to the plurality of input leads 1 of the driving chip 10.

Further, the power supply wires 132, 133 and 134 extend from the second input pads 122 to connect to the PCB 200. Thus, the power supply wires 132, 133 and 134 supply power signals supplied from the PCB 200 to the second input pads 122, thereby providing the power signals to the leads 1 of the driving chip 10. In an exemplary embodiment, the power supply wires 132, 133 and 134 include driving voltage wires to which outside driving voltage signals are applied, and a ground voltage wire to which a ground voltage signal is applied. For example, in an exemplary embodiment of the present invention in FIG. 3, a pair of power supply wires 133 and 132, the driving voltage is applied to the power supply wire 133 and the ground voltage is supplied to the power supply wire 132, each disposed in the chip mounting area 115. Further, power supply wire 134, disposed outside the chip mounting area 115, also receives the driving voltage.

Referring to FIG. 4, in an alternative exemplary embodiment of the present invention, the power supply wire 133 which receives the driving voltage and the power supply wire 132 which receives the ground voltage are disposed inside the chip mounting area 115, while the power supply wire 134 disposed outside the chip mounting area 115 also receives the ground voltage.

Referring back to FIG. 3, the first bridge wire 135a and the second bridge wire 135b branch from the power supply wire 132 and the power supply wire 134, respectively. Further, the first bridge wire 135a and the second bridge wire 135b each connect to a corresponding input pad 123, each having a predetermined voltage, e.g., the driving voltage or the ground voltage, supplied from the power supply wire 132 and the power supply wire 134, respectively, through the first bridge wire 135a and the second bridge wire 135b, respectively.

In addition, data lines 111 of the LCD panel 103 connect to respect output pads 124, as shown in FIG. 3. In an exemplary embodiment, the data lines 111 are spaced equidistantly from each other in the display area of the LCD panel 103. Further, the data lines 111 may be grouped such that data lines 111 of a given group are narrowly spaced from each other, and may therefore be formed in the non-effective display area corresponding to a peripheral edge of the first display panel 101, thereby facilitating connection with the driving chip 10.

A configuration of the LCD panel assembly 100 of the LCD according to an exemplary embodiment of the present invention will now be described in further detail with reference to FIGS. 1A and 3.

The first input pads 121 and the second input pads 122 are connected to the plurality of wires formed on the first display panel 101, e.g., the signal wires 131 and the each of the power supply wires 132, 133 and 134, respectively. The output pads 124 are connected to the data lines 111.

As described above in greater detail, the signal wires 131 are supplied with driving and/or control signals from the PCB 200 to apply the driving and/or control signals to the first input pads 121. The power supply wires 132, 133 and 134 are supplied with power signals from the PCB 200 to apply the power signals to the second input pads 122.

Meanwhile, the power supply wires 133 and the power supply wire 134 may each have a driving voltage signals applied, and a ground voltage may be applied to the power supply wire 132. The power supply wires 132, 133 and 134 may be disposed inside the chip mounting area 115, or, in an alternative exemplary embodiment, the power supply wires 132, 133 and 134 may be disposed outside the chip mounting area 115.

More specifically, in an exemplary embodiment of the present invention, the power supply wire 133 having the driving voltage applied thereto and the power supply wire 132 having the ground voltage applied thereto may be disposed inside the chip mounting area 115, e.g., between respective input pads 121 and 122 and a corresponding output pad 124, as shown in FIG. 3. In addition, the power supply wire 134 having the driving voltage applied thereto may be disposed outside the chip mounting area 115. Thus, it follows that second input pads 122 associated with a respective power supply wire 132, 133 or 134 is connected to either inside or outside the chip mounting area 115 to supply the driving voltages and/or the ground voltage, as required. In an exemplary embodiment shown in FIG. 3, for example, the power supply wire 134 having the driving voltage applied thereto is disposed outside the chip mounting area 115 while the power supply wire 133 having the driving voltage applied thereto is disposed inside the chip mounting area 115, and the power supply wire 134 and the power supply wire 133 are electrically connected to each other by an internal circuit (not shown) of the driving chip 10.

The first bridge wire 135a and the second bridge wire 135b may each branch from the power supply wire 134 having the driving voltage applied thereto or the power supply wire 132 having the ground voltage applied thereto, respectively, with each being connected to a corresponding second input pad 122. Further, the first bridge wire 135a and the second bridge wire 135b may each be connected to an associated option pad 123.

More specifically, the power supply wire 132 having the ground voltage applied thereto is disposed inside the chip mounting area 115 and is connected to the second input pad 122, thereby applying a ground voltage potential to the second input pad 122. In addition, the first bridge wire 135a may extend from the second input pad 122 having power wire 132 having the ground voltage applied thereto connected thereto or, alternatively, from the power supply wire 132 to then be connected to the option pad 123 adjacent to the second input pad 122.

In an exemplary embodiment, the first bridge wire 135a which applies the ground voltage to the option pad 123 may extend from power supply wire 132 having the ground voltage applied thereto or the second input pad 122 connected to the power supply wire 132 in an outside peripheral area of the chip mounting area 115, and may be bent at least once to connect to the option pad 123. Accordingly, the option pad 123 connected to the first bridge wire 135a may have a low voltage level, and the option lead 2 of the driving chip 10 connected to a corresponding option pad 123 may go to a low state, thereby controlling an operation of the driving chip 10.

In addition, the power supply wire disposed outside the chip mounting area 115, e.g., the power supply wire 134 having the driving voltage applied thereto may be connected to the second input pad 122 having the driving voltage potential applied thereto. Further, the second bridge wire 135b may extend upward in a substantially vertical direction away from a surface of the second input pad 122 having the power supply wire 134 having the driving voltage applied thereto connected thereto or, alternatively, from the power supply wire 134 having the driving voltage applied thereto to then connect to an option pad 123 adjacent to the second input pad 122.

An alternative exemplary embodiment of the present embodiment in which the second bridge wire 135b extends, e.g., branches from the power supply wire 134 having the driving voltage applied thereto will now be described in further detail by way of example with reference to FIGS. 1B, 2 and 4.

An option pad 123 connected to the second bridge wire 135b may have a high voltage level, and an associated option lead 2 of the driving chip 10 connected to a corresponding option pad 123 may therefore have a high state, thereby controlling an operation of the driving chip 10. In this case, the second bridge wire 135b which applies the driving voltage to the option pad 123 is disposed outside the chip mounting area 115.

Referring to FIG. 4, the power supply wires 132 and 134, each having a ground voltage applied thereto, and the power supply wire 133 having the driving voltage applied thereto, have a different configuration than a configuration shown in FIG. 3. As shown in FIG. 4, a pair of power supply wires, e.g., the power supply wire 133 having the driving voltage applied thereto and the power supply wire 132 having the ground voltage applied thereto, are disposed inside the chip mounting area 115 between the corresponding input pads 121 and 122 and a corresponding output pad 124. The power supply wire 134 having the ground voltage applied thereto is disposed outside the chip mounting area 115.

Accordingly, when an option pad 123 is at a high voltage level, the option pad 123 is connected to the power supply wire 133 thus having the driving voltage applied thereto and is disposed inside the chip mounting area 115 through a second bridge wire 135b, while an option pad 123 having a low voltage level may be connected to the power supply wire 134 thus having the ground voltage applied thereto and disposed outside the chip mounting area 115 through first bridge wire 135a.

Accordingly, the first bridge wire 135a and the second bridge wire 135b branch from the power supply wire 133 having the driving voltage applied thereto or the power supply wire 132 and the power supply wire 134 each having the ground voltage applied thereto or from the second input pads 122 connected thereto, which are substantially similar to those described above in greater detail with reference to FIG. 3.

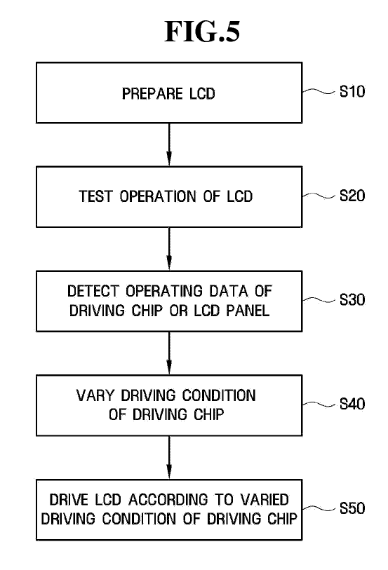

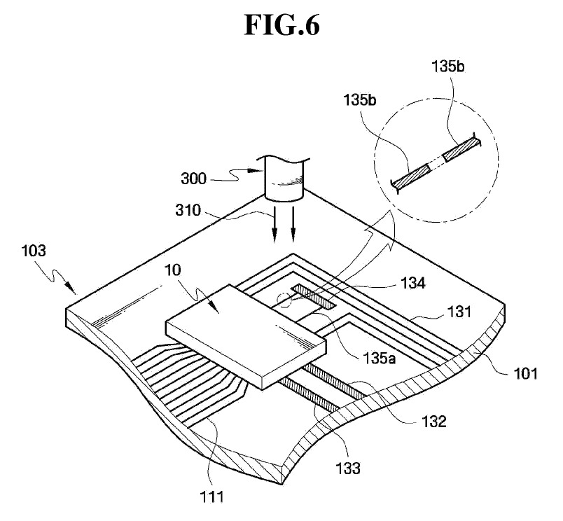

As described above with reference to FIGS. 3 and 4, first bridge wires 135a and second bridge wires 135b are each connected to corresponding option pads 123 to control an operation of the driving chip 10, and extend toward an area outside of a chip mounting area 115. As a result, an operation of the driving chip 10 can be varied in a simplified manner in a method of driving an LCD, which will be described in further below with reference to FIGS. 5 and 6. Accordingly, an LCD panel 100 according to an exemplary embodiment of the present invention is optimally driven according to different driving conditions.

Referring back to FIGS. 1A and 2, the driving chip 10 may be mounted on a side of the LCD panel 103, e.g., in the chip mounting area 115 on the LCD panel 103. Further, the driving chip 10 may include a plurality of input leads 1, option leads 2 and output leads 3, each connected to a corresponding input pads 121 and 122, option pad 123 and output pad 124, respectively, formed in the chip mounting area 115.

Further referring to FIG. 2, a plurality of electronic parts 210 are mounted on the PCB 200 to generate driving, control and power signals of the LCD panel 103 and the driving chip 10. The PCB 200 may be connected to the LCD panel 103 via at least one connection member 220 such as a flexible printed circuit film (“FPC”), for example, but is not limited thereto.

In addition, the connection member 220 may be connected to a connection member mounting area 117 formed adjacent to a side of the LCD panel 103, e.g., the chip mounting area 115 of the LCD panel 103. The connection member mounting area 117 may include a plurality of connection pads 119 which may be connected to a plurality of signal wires (not shown) of the connection member 220.

In an exemplary embodiment, the plurality of connection pads 119 may be connected to the plurality of wires (FIGS. 3 and 4) formed on the LCD panel 103, for example, the plurality of signal wires 131 and the plurality of power supply wires 132, 133, and 134. Accordingly, the PCB 200 may be connected to the driving chip 10 or the LCD panel 103 through the connection member 220, the plurality of connection pads 119 of the connection member mounting area 117, and the plurality of wires formed on the LCD panel 103.

A conductive material 250 may be formed between the driving chip 10 and the LCD panel 103 and/or between the connection member 220 and the LCD panel 103 to facilitate electrically connecting the driving chip 10 to the LCD panel 103 and/or the connection member 220. The plurality of connection leads (FIG. 1) of the driving chip 10 may be connected to the plurality of connection pads formed on the chip mounting area 115 on the LCD panel 103, and/or the connection member 220 may be connected to the plurality of connection pads 119 formed on the connection member mounting area 117 of the LCD panel 103 by the conductive material 250. In exemplary embodiments of the present invention, examples of the conductive material 250 include, but are not limited to, an anisotropic conductive film (“ACF”).

The LCD panel 103 may be connected to the PCB 200 by the connection member 220, and the plurality of electronic parts 210 may be mounted directly on the LCD panel 103 and then connected to the plurality of wires formed on the LCD panel 103 to be connected to the driving chip 10.

Further, a backlight assembly (not shown) may be disposed below the LCD panel assembly 100. The backlight assembly supplies the LCD panel 103 with light, and may include, for example, a lamp unit (not shown), a light-guiding plate (not shown), and a plurality of optical sheets (not shown).

Hereinafter, a method of driving an LCD according to an exemplary embodiment of the present invention will now be described in further detail with reference to FIGS. 1A, 2-3, 5 and 6, as well as Table 1.

FIG. 5 is a flowchart of a method of driving an LCD according to an exemplary embodiment of the present invention, and FIG. 6 is a processing diagram illustrating a step of varying the operation of a driving chip in the method of driving the LCD according to the exemplary embodiment of the present invention in FIG. 5.

Referring to FIGS. 1A, 2, 3 and 5, the method of driving an LCD according to the an exemplary embodiment of the present invention includes preparing the LCD (step S10), testing an operation of the LCD (step S20), detecting operating data of a driving chip or an LCD panel (step S30), varying a driving condition of the driving chip (step S40) and driving the LCD according the varied driving condition of the driving chip (step S50).

More specifically, the LCD including an LCD panel 103 having a plurality of data lines 111 and at least one driving chip 10 mounted thereon is prepared in step S10. The LCD panel 103 may further include a plurality of wires connected to the driving chip 10, and the plurality of wires may include a plurality of signal wires 131 and a plurality of power supply wires 132, 133 and 134, as described above in greater detail. The plurality of wires may be connected to a plurality of connection pads formed on a chip mounting area 115, e.g., to a plurality of first input pads 121 and a plurality of second input pads 122. The plurality of wires is connected to an outside area of the LCD panel 103, e.g., to a PCB 200. Accordingly, a plurality of signals supplied from the PCB 200, e.g., driving, control and power signals, may be supplied to the driving chip 10 and/or the LCD panel 103 through the plurality of wires.

The LCD panel 103 may further include a plurality of first bridge wires 135a and a plurality of second bridge wires 135b each branching from a respective plurality of wires, e.g., the plurality of power supply wires 132, 133 and 134. More specifically, the plurality of first bridge wires 135a and the plurality of second bridge wires 135b may each branch from a corresponding power supply wire 132, 133 and 134 to be connected to an associated option pad 123 of the plurality of option pads 123, and may thereby supply the driving chip 10 with driving voltages or ground voltages supplied from the power supply wires 132, 133 and 134 through the plurality of option pads 123.

Next, in step S20, operation of the driving chip 10 and/or the LCD panel 103 is tested by driving the LCD having the configuration described above. When testing the operation of the driving chip 10 and/or the LCD panel 103, the operation of the driving chip 10 is controlled in a default state. In other words, the plurality of option leads 2 of the driving chip 10 control the operation of the driving chip 10 by voltages supplied from the first bridge wire 135a and the second bridge wire 135b, each having, e.g., the driving voltage or the ground voltage. Accordingly, when the LCD is driven in the default state, the plurality of option leads 2 of the driving chip 10 are connected to the LCD panel 103 through the first bridge wire 135a and the second bridge wire 135b, and the operation of the driving chip 10 is thereby initialized.

Next, during step S20 of testing the operation of the driving chip 10 and/or the LCD panel 103 by driving the LCD, operating data of the driving chip 10 and/or the LCD panel 103, which is generated according to driving conditions or environments, is detected (step S30). A computer system, for example, but not being limited thereto, having a detection program stored therein may be utilized in detecting the operating data.

Next, in order to adjust driving conditions of the driving chip 10 and/or the LCD panel 103 detected in step S30, the operation of the driving chip 10 and/or the LCD panel 103 is varied by controlling the driving chip 10 in step S40.

More specifically, the method of varying the operation of the driving chip 10 by controlling the same according to step S40 may include, for example, varying voltages applied to the plurality of option leads 2 of the driving chip 10, as will now be described in greater detail with reference to Table 1 and FIGS. 3, 5 and 6.

As described in greater detail above, the plurality of option leads 2 of the driving chip 10 receive voltages from the power supply wires 132, 133 and 134 through the first bridge wires 135a and the second bridge wires 135b branching from the power supply wires 132, 133 and 134, to set a state of the plurality of option leads 2. In an exemplary embodiment, a method of varying voltages applied to the plurality of option leads 2 includes cutting the first bridge wires 135a and/or the second bridge wires 135b connected to a corresponding option lead 2 of the driving chip 10.

For example, referring to Table 1 and FIGS. 1, 3 and 6, an option lead 2 of the driving chip 10 may be connected to a second bridge wire 135b branching from a power supply wire 132 for having a ground voltage applied thereto formed on the LCD panel 103. Accordingly, the default state of the driving option lead 2 may set to be a low state. In addition, the driving chip 10 may be driven by an outside voltage due to the driving option lead 2 in the low state, in alternative exemplary embodiments, wherein in order to vary an operation of the LCD driven, the operation of the driving chip 10 is controlled by changing the magnitude of a voltage applied to the driving option lead 2.

More specifically, as shown in FIG. 6, when the second bridge wire 135b connected to the option lead 2 is cut, the second bridge wire 135b is opened, e.g., is electrically disconnected so that voltage signals do not flow through the second bridge wire 135b. Accordingly, the driving option lead 2 goes to a floating state, as described above in greater detail. Thus, as shown in Table 1, the driving option lead 2 is pulled up by an internal circuit (not shown) of the driving chip 10.

When the driving option lead 2 is floated and is pulled up, a state of the driving option lead 2 transitions from a low state to a high state. Thus, the operation of the driving chip 10 is controlled such that the driving chip 10 is driven by an externally applied current.

In an exemplary embodiment, the second bridge wire 135b extends toward an outside portion of the chip mounting area 115, as described above. Thus, even after the driving chip 10 is mounted on the LCD panel 103, operation of the driving chip 10 can be controlled in a simplified manner as described herein.

More specifically, as shown in FIG. 6, a laser beam generator 300 may be used to cut the second bridge wire 135b, for example, but is not limited thereto. For example, the second bridge wire 135b may be cut by melting the second bridge wire 135b extending toward the outside portion of the chip mounting area 115 using a laser beam 310 generated from the laser beam generator 300. Further, the second bridge wire 135b may be made of substantially the same material as a material used to form the plurality of wires of the LCD panel 103, such as a metal, for example. In addition, any type of laser beam generator 300 which is capable of melting the material can be used as the laser beam generator 300 in alternative exemplary embodiments of the present invention.

Next, the LCD having the driving chip 10 having an operation which is varied in step S40 is driven in step S50. As a result, operation of the LCD is effectively optimized according to driving conditions and/or environments.

As described herein, when an operational error occurs to an LCD due to changed driving conditions and/or driving environments, or when optimized driving of the LCD is desired by varying driving conditions of a driving chip therein, a method of driving an LCD according to exemplary embodiments of the present invention provide for changing the driving condition of the driving chip in a simple manner, even after fabrication of the chip is complete.

More specifically, exemplary embodiments of the present invention as described herein have, as an example of controlling the operation of the driving chip, vary a magnitude of a voltage applied to one of a plurality of option leads of the driving chip 10, but alternative exemplary embodiments of the present invention are not limited to the examples described herein. It is to be understood that when varying a magnitude of a voltage applied to one of a plurality of option leads of the driving chip, operation of the driving chip may also be controlled by repeatedly performing steps S10 through S50, or simultaneously cutting first bridge wires 135a and/or second bridge wires 135b using a laser beam, for example.

Further, it should also be understood that a chemical vapor deposition (“CVD”) repairing method, for example, may be employed to connect or repairing a first bridge wire 135a or a second bridge wire 135b which has been opened (e.g., melted or disconnected) by using the steps described above.

As described above, according to the present invention, even after a driving chip has been mounted on an LCD panel, optimized driving of an LCD can be achieved by controlling an operation of the driving chip according to various driving conditions and/or environments.

The present invention should not be construed as being limited to the exemplary embodiments set forth herein. Rather, these exemplary embodiments are provided so that this disclosure will be thorough and complete and will fully convey the concept of the present invention to those skilled in the art.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A liquid crystal display comprising:
an insulating substrate;
a driving chip mounted in a chip mounting area on the insulating substrate and comprising a plurality of input leads and a plurality of option leads;
a plurality of input pads formed in a chip mounting area, each input pad of the plurality of input pads being connected to a corresponding input lead of the plurality of input leads, wherein an input pad of the plurality of input pads supplies the driving chip with a power signal supplied from a power supply wire of a plurality of power supply wires;
a plurality of option pads formed in a chip mounting area, and which control the driving chip by applying the power signal or floating; and
a plurality of bridge wires connecting the option pads, wherein part of the bridge wires are formed out of the chip mounting area and branch from the power supply wire.

2. The liquid crystal display of claim 1, wherein a part of the bridge wire connects to the option pads, and other part of bridge wire connects to the power supply wire in the chip mounting area.

3. The liquid crystal display of claim 2, wherein other parts of the bridge wires protrude outward from the chip mounting area.

4. The liquid crystal display of claim 1, a part of the bridge wires connects to the option pads, and an other part of the bridge wires connects to the power supply wire out of the chip mounting area

5. The liquid crystal display of claim 1, wherein an option lead of the plurality of option leads is connected to an option pad of the plurality of option pads and receives the power signal from a corresponding bridge wire of the plurality of bridge wires to control an operation of the driving chip according to a voltage level of the power signal.

6. The liquid crystal display of claim 5, wherein the plurality of option leads comprises a signal option lead, a voltage option lead and a driving option lead, wherein the signal option lead controls one of a driving signal and a control signal generated from the driving chip, the voltage option lead controls a magnitude of a driving voltage of the driving chip and the driving option lead controls a driving mode of the driving chip.

7. The liquid crystal display of claim 5, wherein the plurality of power supply wires comprises a driving voltage wire to which a driving voltage signal is applied and a ground voltage wire to which a ground voltage signal is applied, and the plurality of bridge wires applies one of the driving voltage signal and the ground voltage signal to an option lead of the plurality of option leads.

8. The liquid crystal display of claim 5, wherein an internal circuit of the driving chip pulls up or pulls down a floated option lead when a bridge wire of the plurality of bridge wires connected to the floated option lead of the plurality of option leads is opened.

9. The liquid crystal display of claim 1, wherein the driving chip is mounted by a chip-on-glass type.

10. The liquid crystal display of claim 1, wherein
the driving chip further comprises a plurality of signal leads to which one of an outside driving signal and an outside control signal is applied,
the insulating substrate comprises a plurality of signal pads, each of which is connected to a corresponding signal lead of the plurality of signal leads, and
signal pads of the plurality of signal pads are each connected to a signal wire of a plurality of signal wires formed on the insulating substrate.

11. A method of adjusting a driving mode of a liquid crystal display, the method comprising:
forming the liquid crystal display, the liquid crystal display comprising:
an insulating substrate;
a driving chip mounted on the insulating substrate and comprising a plurality of input leads and a plurality of option leads;
a plurality of input pads formed on the insulating substrate, each input pad of the plurality of input pads being connected to a corresponding input lead of the plurality of input leads, wherein an input pad of the plurality of input pads supplies the driving chip with a power signals supplied from a power supply wire of a plurality of power supply wires; and
a plurality of option pads formed on the insulating substrate, each option pad of the plurality of option pads being connected to a corresponding option lead of the plurality of option leads,
wherein a driving mode of the driving chip of the liquid crystal display is controlled according to a voltage level of the power signal supplied through a bridge wire of a plurality of bridge wires;
testing an operation of the liquid crystal display; and
adjusting the driving mode of the liquid crystal display by selectively opening a bridge wire of the plurality of bridge wires.

12. The method of claim 11, wherein the driving chip is mounted in a chip mounting area on the insulating substrate;
a bridge wire of the plurality of bridge wires extend to the outside of the chip mounting area; and
adjusting the driving mode of the liquid crystal display by floating an option lead of the plurality of option leads.

13. The method of claim 12, wherein a voltage level of an option lead of the plurality of option leads is adjusted by an internal circuit of the driving chip when the option lead of the plurality of option leads is floated.

14. The method of claim 13, wherein a voltage level of the option lead is pulled up or pulled down by the internal circuit of the driving chip when the option lead of the plurality of option leads is floated.

15. The method of claim 11, wherein the selectively opening the bridge wire includes cutting the bridge wire.

16. The method of claim 15, wherein the selectively opening the bridge wire includes cutting the bridge wire with a laser.

17. The method of claim 17, wherein the plurality of option leads comprises a signal option lead, a voltage option lead and a driving option lead, and the method further comprises:
controlling one of a driving signal and a control signal generated from the driving chip with the signal option lead;
controlling a magnitude of a driving voltage of the driving chip with the the voltage option lead; and
controlling a driving mode of the driving chip with the driving option lead.

18. The method of claim 17, wherein the plurality of power supply wires comprises a driving voltage wire to which a driving voltage signal is applied and a ground voltage wire to which a ground voltage signal is applied, and the plurality of bridge wires applies one of the driving voltage and the ground voltage to an option lead of the plurality of option leads.

19. A method of driving a liquid crystal display, the method comprising:
forming the liquid crystal display, the liquid crystal display comprising:
an insulating substrate;
a driving chip mounted on the insulating substrate and comprising a plurality of input leads and a plurality of option leads;
a plurality of input pads formed on the insulating substrate, each input pad of the plurality of input pads being connected to a corresponding input lead of the plurality of input leads, wherein an input pad of the plurality of input pads supplies the driving chip with a power signals supplied from a power supply wire of a plurality of power supply wires; and
a plurality of option pads formed on the insulating substrate, each option pad of the plurality of option pads being connected to a corresponding option lead of the plurality of option leads,
wherein a driving mode of the driving chip of the liquid crystal display is controlled according to a voltage level of the power signal supplied through a bridge wire of a plurality of bridge wires;
testing an operation of the liquid crystal display;
adjusting the driving mode of the liquid crystal display by selectively opening a bridge wire of the plurality of bridge wires;
connecting an option lead of the plurality of option leads to an option pad of the plurality of option pads to receive the power signal from a corresponding bridge wire; and
controlling an operation of the driving chip according to a voltage level of the power signal.
